(19) United States
(12) Patent Application Publication
(10) Pub. No.: US 2010/0150825 A1
(43) Pub. Date: Jun. 17, 2010

(54) Method for effectively controlling the temperature of oxide-coated short-channel-length metallic structures

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 12/653,292

(22) Filed: Dec. 11, 2009

Related U.S. Application Data
(60) Provisional application No. 61/201,956, filed on Dec. 17, 2008.

(51) Int. Cl. C01B 3/26

(52) U.S. Cl. 423/651

(57) ABSTRACT

A method for the partial oxidation of hydrocarbons is provided wherein an endothermic catalyst and an oxidation catalyst are positioned upon a short channel-length metallic substrate; the endothermic catalyst positioned under a surface layer of the oxidation catalyst positioned on the metallic substrate. A fuel-rich supply of hydrocarbons and oxygen is then passed over the substrate. The method includes providing an oxidation catalyst on at least a portion of a surface of the metallic substrate wherein a hydrocarbon is oxidized by an oxygen mass-transfer-limited reaction on the oxidation catalyst surface; and providing an endothermic catalyst on the metallic substrate below the oxidation catalyst surface whereby an endothermic reaction follows the oxygen mass-transfer-limited reaction below the oxidation catalyst surface.

### CROSS-REFERENCE

This application claims the benefit of U.S. Provisional Application

No. 61/201,956; filed on Dec. 17, 2008.

### FIELD OF THE INVENTION

This invention relates to improved catalytic reactors. In one specific aspect, this invention also relates to a means for effectively controlling the temperature of oxide-coated short-channel-length metallic structures.

### BACKGROUND OF THE INVENTION

### Brief Description of the Related Art

The prior art includes processes for partial oxidation of hydrocarbons to produce a hydrogen-rich gas, an exothermic initial reaction of a portion of the hydrocarbons followed by an endothermic reaction of the remainder with combustion products. With high efficiency short-channel-length metallic substrates, the oxygen content must be limited in order to control the maximum temperature of the exothermic initial reaction to below the substrate allowable value, with resultant operation coke formation.

It is therefore an object of the present invention to provide a means for effectively controlling the temperature of oxide-coated short-channel-length metallic structures while providing for the partial oxidation of hydrocarbons.

### SUMMARY OF THE INVENTION

It has now been found that endothermic reactions within a catalytic structure can limit the maximum surface temperature of the metal catalyst substrate from the increase in exterior surface temperature caused by the exothermic reactions required for the overall process. In particular, in the reforming of diesel fuel to produce hydrogen without the addition of water, the required exothermic reaction of fuel with oxygen can reach temperatures well over those high enough to damage typical reforming catalyst metallic structures. Thus, the oxygen must be held to a value which limits temperature but concurrently allows carbon buildup on the catalyst downstream. With the present invention, the metallic substrate is maintained at a safe temperature by endothermic reforming reactions in catalyst layers positioned below the surface catalyst utilizing combustion products from the overlying oxidation and thus allowing higher oxygen concentrations. Accordingly, the endothermic catalyst layer must be at least several times thicker than that required for the initial exothermic reaction.

Thus, the invention provides a method for reforming hydrocarbons over a short-channel-length metallic substrate wherein a hydrocarbon is oxidized by an oxygen mass-transfer-limited reaction on a catalyst surface followed by an endothermic reaction below the surface catalyst layer.

In the present invention, it is preferred that the catalyst support be pre-impregnated with the endothermic catalytic metal before coating of the exothermic surface layer on the metallic substrate to assure subsurface reaction. Typically several coating layers will be required to achieve desirable adherence. A uniform dispersion of the catalytic metal on the support is preferred. Rhodium is typically used for both the exothermic oxidation catalyst and the endothermic under layer. However, platinum is suitable (and lower cost) for the oxidation over layer. Any metallic catalyst structure may be used but short-channel-length structures are preferred.

### BRIEF DESCRIPTION OF THE DRAWINGS

FIG. 1 depicts a reforming method of the prior art.

FIG. 2 depict a catalyst element of the present invention.

### DETAILED DESCRIPTION OF THE PREFERRED EMBODIMENTS OF THE INVENTION

In a preferred embodiment of the present method, a reforming catalyst for the partial oxidation of hydrocarbons is provided wherein the catalyst, in turn, provides for the endothermic reaction of hydrocarbons, referred to herein as the “endothermic catalyst”. The catalyst is positioned upon, or coated onto, at least a portion of a substrate suitable for holding or receiving such a catalyst; preferably a short-channel-length metallic substrate. A surface layer of an oxidation catalyst, referred to herein as the “oxidation catalyst,” is also positioned upon at least a portion of the substrate provided thereby supporting the partial oxidation of hydrocarbons.

In various preferred embodiments of the present invention, the endothermic catalyst may comprise rhodium and the oxidation catalyst may comprise platinum, rhodium, or other known oxidation catalysts.

In one method of the present invention, a porous catalyst layer of greater than about one tenth millimeter thickness positioned on at least a portion of a support structure and having a BET surface area greater than about one hundred square meters per gram is used to reform a mixture of diesel fuel and air having an equivalence ratio of 3.1. Although the adiabatic flame temperature for complete conversion is only about 800° Celsius, the peak temperature can be in excess of 1500° Celsius without endothermic cooling.

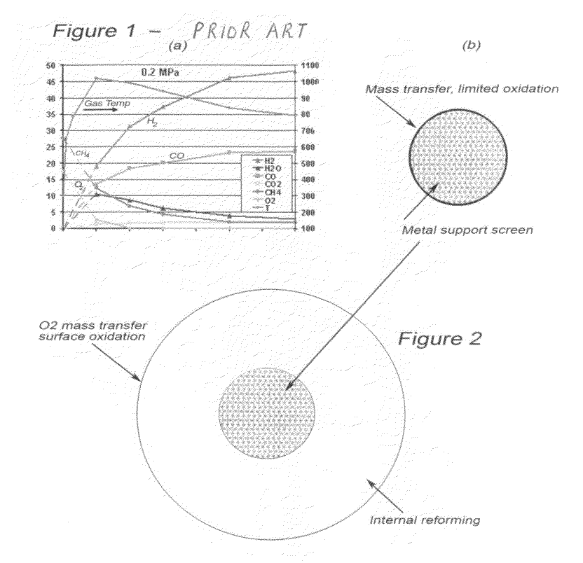

FIG. 1a shows the gas temperature from the reactor inlet to the reactor exit using prior art catalyst screens with catalytically coated metal elements as shown in FIG. 1b. The catalyst support coating is typically limited in thickness to assure desirable adhesion of the coating to the metal substrate. The rhodium catalyst is applied to the support oxide layer surface. The result as shown in the experimental data is a rapid consumption of oxygen with a rapid rise in the gas temperature. The metal temperature is even higher.

To assure metal substrate survival, the oxygen concentration must be limited to a value which allows soot build-up on the catalyst. Note that the endothermic reactions lower the exit temperature. Although the catalyst can be periodically regenerated by soot burn off, this is undesirable or even not feasible in many applications.

FIG. 2 depicts an element of a catalyst-coated screen according to the method of the present comprising a catalyst layer at least several times thicker than conventional coatings. To assure effective reforming activity in the subsurface catalyst, the catalytic metal, typically rhodium, may be pre-coated on the support before coating on the short-channel-length screen. Typically the coated powder is coated in more than one layer to avoid mud-cracking and loss of adhesion. The subsurface reforming not only lowers subsurface temperature but reduces the number of screens required for a given conversion. This allows a higher surface temperature and higher oxygen concentration without damage to the underlying metal structure or substrate thereby avoiding coke formation.

Although the present invention has been described in detail with respect to providing a method for effectively controlling the temperature of oxide-coated short-channel-length metallic structures, it will be apparent that the invention is capable of numerous modifications and variations, apparent to those skilled in the art, without departing from the spirit and scope of the invention.

1. A method for partial oxidation of hydrocarbons comprising:
a) providing a metallic catalyst substrate;
b) providing an endothermic catalyst;
c) providing an oxidation catalyst;
d) positioning the endothermic catalyst under a surface layer of the oxidation catalyst on the metallic substrate; and
e) passing a fuel rich supply of hydrocarbons and oxygen over the substrate.

2. The method for partial oxidation of hydrocarbons of claim 1 wherein the endothermic catalyst comprises rhodium.

3. The method for partial oxidation of hydrocarbons of claim 2 wherein the oxidation catalyst comprises platinum.

4. The method of claim 1 wherein the metallic catalyst substrate comprises a short chan

5. The method for partial oxidation of hydrocarbons of claim 2 wherein the oxidation catalyst comprises rhodium.

6. A method for reforming hydrocarbons over a shortchannel-length metallic substrate comprising:
a) providing an oxidation catalyst on at least a portion of a surface of the metallic substrate wherein a hydrocarbon is oxidized by an oxygen mass-transfer-limited reaction on the oxidation catalyst surface; and
b) providing an endothermic catalyst on the metallic substrate below the oxidation catalyst surface whereby an endothermic reaction follows the oxygen mass-transfer-limited reaction below the oxidation catalyst surface.
